(19) United States
(12) Patent Application Publication
(10) Pub. No.: US 2020/0311515 A1
(43) Pub. Date: Oct. 1, 2020

(54) METHOD OF ESTIMATING CLAMP FORCE OF BOLT

(71) Applicants: HYUNDAI MOTOR COMPANY, Seoul (KR); KIA MOTORS CORPORATION, Seoul (KR); IUCF-HYU (Industry-University Cooperation Foundation Hanyang University), Seoul (KR)

(72) Inventors: Jae-Soo Gwon, Yongin-si (KR); Gyung-Min Toh, Seoul (KR); Wan-Seung Kim, Mokpo-si (KR); Jun-Hong Park, Seongnam-si (KR)

(21) Appl. No.: 16/696,545

(22) Filed: Nov. 26, 2019

(30) Foreign Application Priority Data
Mar. 28, 2019 (KR) 10-2019-0035599

(51) Int. Cl. G06N 3/04; G06N 3/08

(52) U.S. Cl. CPC G06N 3/0445; G06N 3/08

(57) ABSTRACT

A method of estimating clamp force of a bolt may include converting and analyzing, by a signal processing and analyzing device, a learning signal for the clamp force of the bolt, the learning signal being acquired by a data acquirement device; comparing the learning signal classified into groups according to signal characteristics by the converting and analyzing, with a discriminant signal desired to be estimated; and estimating, as clamp force of the discriminant signal, clamp force corresponding to a signal of a most similar group among the learning signal classified into the groups by the comparing.

### CROSS-REFERENCE(S) TO RELATED APPLICATIONS

The present application claims priority to Korean Patent Application No. 10-2019-0035599, filed on Mar. 28, 2019, the entire contents of which is incorporated herein for all purposes by this reference.

### BACKGROUND OF THE DISCLOSURE

### Field of the Disclosure

The present invention relates to a method of estimating clamp force of a bolt which is coupled as a fastening unit.

### Description of Related Art

In general, a bolt is used as an important factor for coupling between components.

Bolts to be used in junctions of steel structures are required to comply with regulations. Clamp force of such a bolt may be strictly controlled.

In Korean industrial Standards (KS), bolts are classified into type A and type B according to a torque coefficient, and an appropriate torque coefficient for each type is defined.

KS regulates that an average of a torque coefficient for A-type bolts ranges 0.11 to 0.15, and an average of a torque coefficient for B-type bolts ranges 0.15 to 0.19.

Fastening clamp force of a bolt may be determined from a torque value, a torque coefficient, and the diameter of the bolt. Desired fastening clamp force may be obtained by adjusting the torque value.

A tightening method has been used to control the clamp force of the bolt. The bolt tightening method is classified into a torque control method and a turn-of-nut method.

The turn-of-nut method is advantageous in that because a turning angle of a nut is used, distribution of the clamp force is relatively reduced.

On the other hand, the torque control method is advantageous in that the workability is superior because the bolt is tightened using a torque wrench after the upper limit and the lower limit of the torque value have been determined.

However, the torque coefficient of the bolt does not remain constant, and may vary due to various factors such as the length of the bolt which is a physical factor and the temperature which is an environmental factor.

Therefore, the torque control method is disadvantageous in that the distribution of the clamp force increases due to a change in torque coefficient.

Furthermore, in sites, there is an inconvenience in that, after the bolt has been tightened using the torque wrench, it is required to measure the clamp force of the tightened bolt using a separate measuring device.

Hence, to maintain appropriate fastening force of the bolt, it is important to estimate the fastening force of the bolt.

Recently, various estimation techniques using artificial intelligence techniques have been disclosed.

A technique for estimating fastening force of a bolt using an artificial neural network has been provided. FIG. 1 illustrates a method of estimating clamp force of a bolt using such an artificial neural network.

In the conventional method of estimating the clamp force using the artificial neural network, as illustrated in FIG. 1, a cepstral coefficient and a short time Fourier transformation (STFT) are deduced from a signal obtained by a sensor.

With regard to the cepstral coefficient, only a high-frequency factor is extracted from the obtained signal using a high-pass filter to reduce influence of noises.

Subsequently, after representative values of respective frames are extracted, frequency domains divided into several hundreds are multiplied by respective weights having an isosceles triangular distribution, and the result values are added up, so that a determined value is obtained.

A logarithm is applied to the determined value, and the cepstral coefficient is deduced through discrete cosine transform.

In the case of the STFT, the obtained signal is converted into frequency-domain data having several hundreds of frames through Fast Fourier Transform with 50% overlap sections based on short time.

The data processed by the cepstral coefficient and the STFT is characterized in that it is input as a supervised signal, multiple weight matrix layers are formed through a gradient descent method using a cost function, and an estimated value of the clamp force is represented using the weight matrix layers.

However, the conventional estimation technique is problematic in that it is relatively complex and thus it is difficult to perform real-time clamp force estimation, and the accuracy of the estimation is low.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a method of estimating clamp force of a bolt which is relatively simple and has improved accuracy of the estimation, whereby real-time estimation is possible.

Other various aspects of the present invention may be understood by the following description, and become apparent with reference to the exemplary embodiments of the present invention. Also, it is obvious to those skilled in the art to which the present invention pertains that the objects and advantages of the present invention may be realized by the means as claimed and combinations thereof.

In accordance with various exemplary embodiments of the present invention, there is provided a method of estimating clamp force of a bolt, including: converting and analyzing, by a signal processing and analyzing device, a learning signal for the clamp force of the bolt, the learning signal being acquired by data acquirement device; comparing the learning signal classified into groups according to signal characteristics by the converting and analyzing, with a discriminant signal desired to be estimated; and estimating, as clamp force of the discriminant signal, clamp force corresponding to a signal of a most similar group among the learning signal classified into the groups by the comparing.

The converting and analyzing may include signal-processing the input learning signal using a tanh function which is a nonlinear function.

In time series data which is input as the learning signal, a weight may be applied to each of nodes, and the converting and analyzing may include optimizing the weight by Adam optimization.

In the Adam optimization, the weight may be optimized by tracing a course of reducing a loss value determined by a loss function.

The loss value determined by the loss function may be obtained by a following equation.

$$Loss value E = - {\sum }_{k} {t}_{k} log {y}_{k}$$

(k: class number, tₖ: k-th class similarity, yₖ: final output value)

The class similarity may have a value ranging from 0 to 1, and the class number may have a value ranging from 1 to 31.

According to a method of estimating clamp force of a bolt in accordance with various aspects of the present invention, clamp force of a discriminant signal is estimated by a recurrent neural network method using a nonlinear function, a loss function, and Adam optimization. Consequently, a loss value may be minimized, and the accuracy of estimation may be enhanced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a conventional method of estimating clamp force of a bolt.

FIG. 2 illustrates a method of estimating clamp force of a bolt in accordance with various aspects of the present invention.

FIG. 3A, FIG. 3B, FIG. 3C, FIG. 4A, FIG. 4B, FIG. 5, FIG. 6, and FIG. 7 are diagrams for concretely describing detailed steps of the method of estimating the clamp force of the bolt in accordance with various aspects of the present invention.

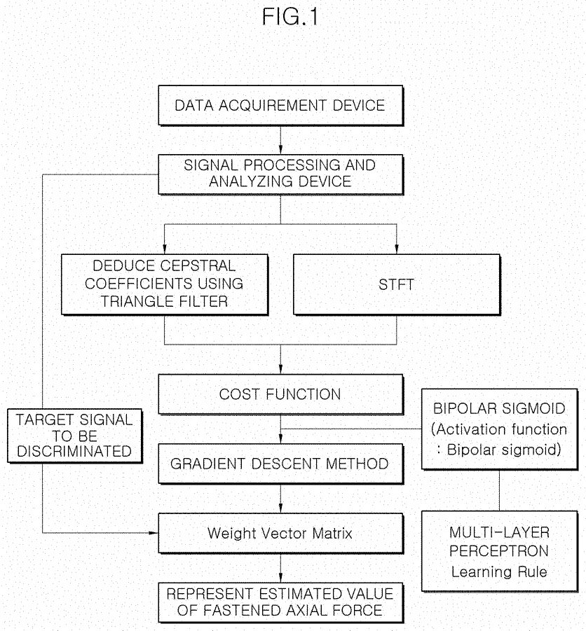

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Exemplary embodiments of the present invention will be described below in more detail with reference to the accompanying drawings to make those skilled in the art fully understand operational advantages and objects of the present invention.

If in the specification, detailed descriptions of well-known functions or configurations would unnecessarily obfuscate the gist of the present invention, the detailed descriptions will be shortened or omitted.

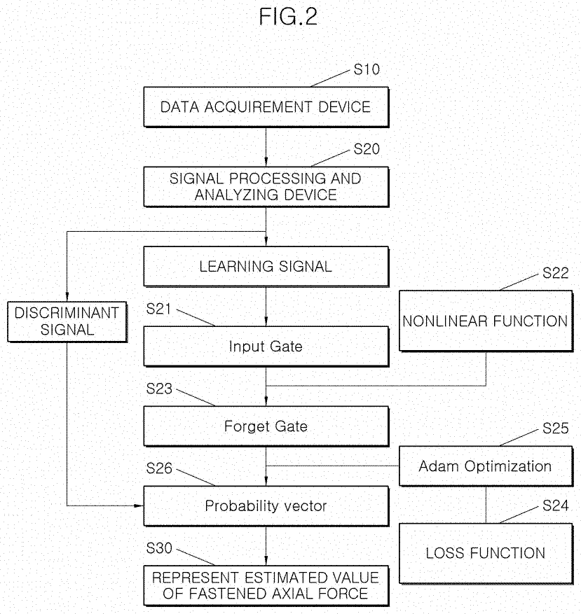

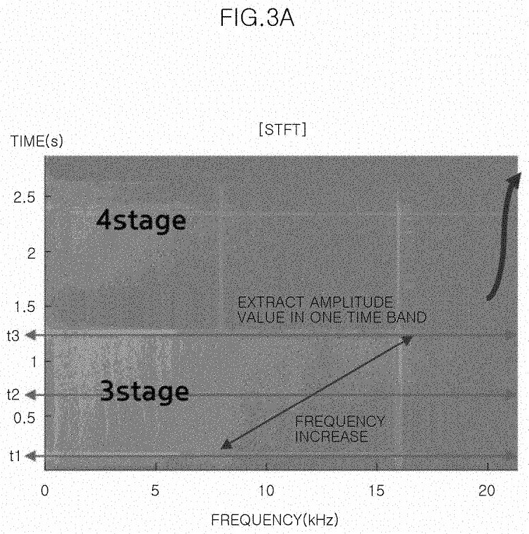

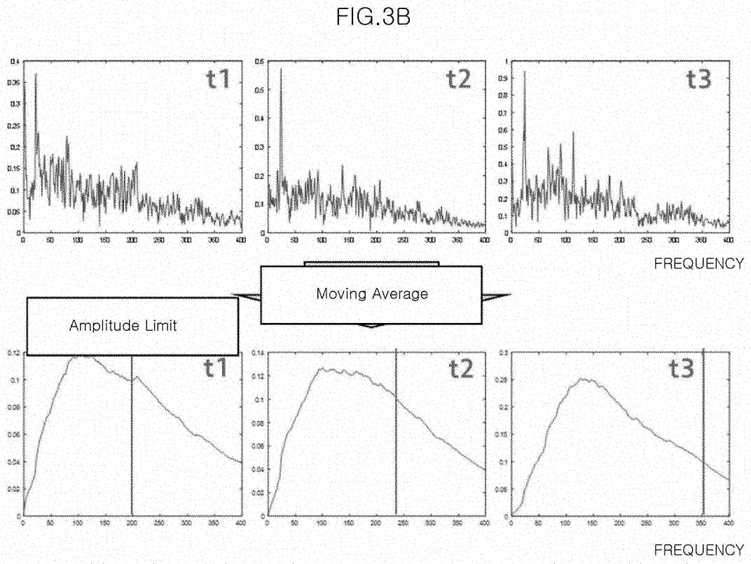

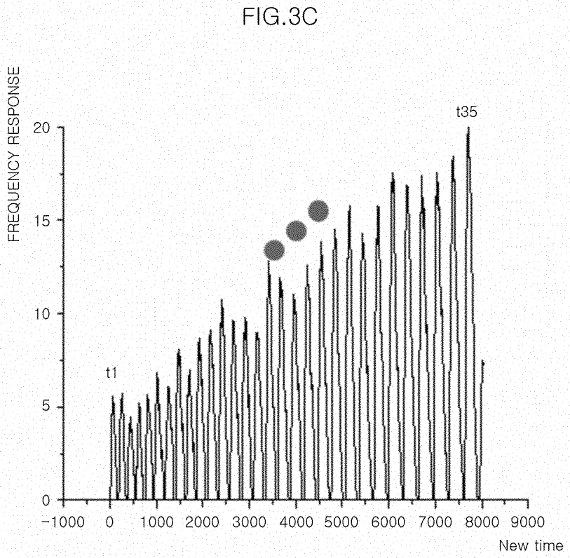

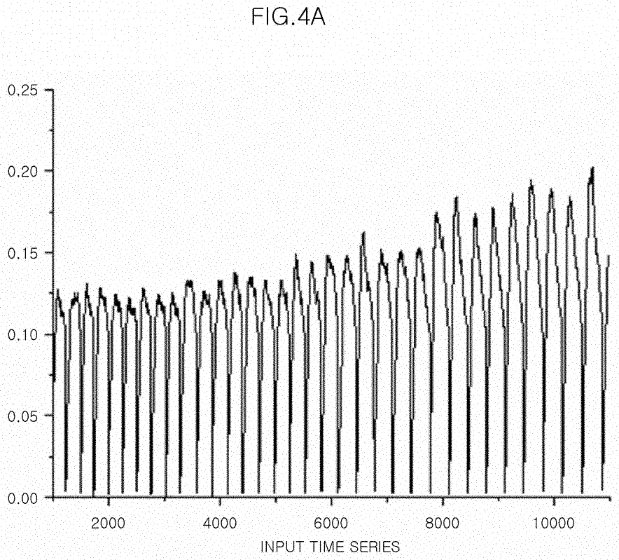

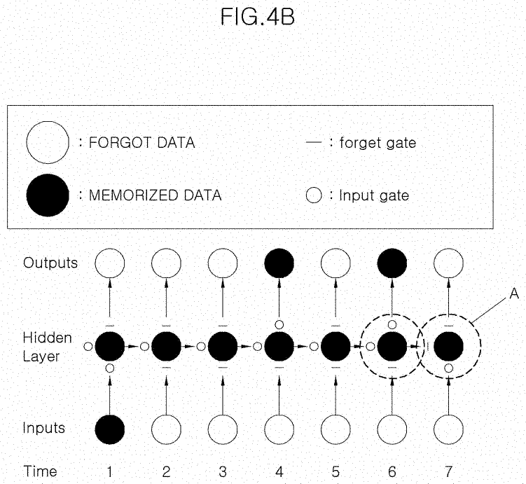

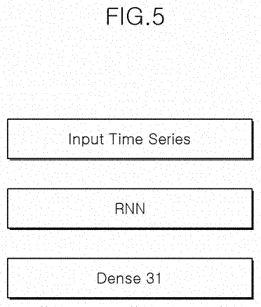

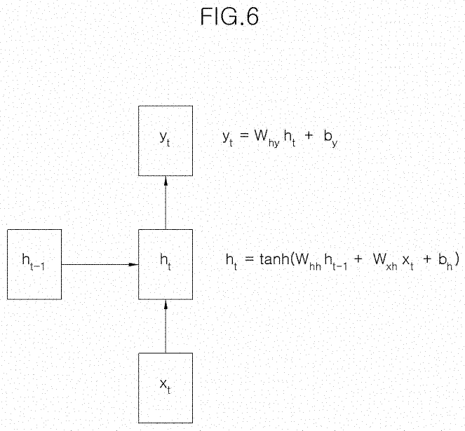

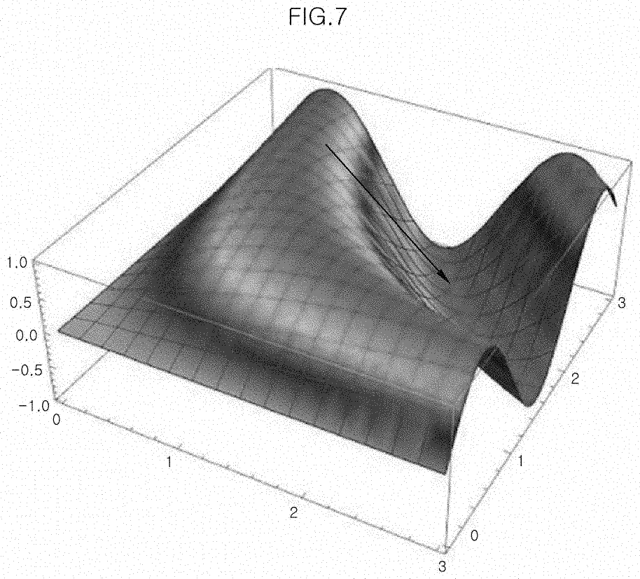

FIG. 2 illustrates a method of estimating clamp force of a bolt in accordance with various aspects of the present invention, and FIGS. 3A to 7 are diagrams for concretely describing detailed steps of the method of estimating the clamp force of the bolt in accordance with various aspects of the present invention.

Hereinafter, a method of estimating clamp force of a bolt in accordance with various exemplary embodiments of the present invention will be described with reference to FIG. 2, FIG. 3, FIG. 4, FIG. 5, FIG. 6, and FIG. 7.

The present invention is to relatively simply and precisely estimate in real time the clamp force of the bolt using a recurrent neural network (RNN) method, compared to that of a conventional method of estimating clamp force of a bolt using an artificial intelligence technique.

The overall process of the method will be described with reference to FIG. 2. The method includes acquiring time series data through a data acquirement device (at step S10), analyzing the acquired time series data by a signal processing and analyzing device (at step S20), and deducing an estimated value of the clamp force of the bolt (at step S30).

Here, the acquired time series data includes information based on a fastening degree.

At the step of analyzing the acquired time series data, when learning signal data is input to an input gate of the long short term memory (LSTM), (at step S21), it is input to a forget gate of the long short term memory (LSTM), (at step S23) while information is exchanged between time series through a nonlinear function (at step S22). In the forget gate, influence of data of a front portion of the time series on data of a rear portion thereof is determined. If the influence is significant, a high weight is given, and if the influence is insignificant, it is removed from a memory.

The weight is optimized to properly perform a valid analysis on the input gate and an analysis of the influence on the forget gate through an Adam optimization technique (at step S25) using a loss function (at step S24). The analyzed time series data is represented as probability vectors by fastening force groups (at step S26) and compared with discriminant data which is a target to be estimated. Thereafter, the fastening force of a group having the highest probability is represented as an estimated value of the corresponding discriminant signal (at step S30).

In detail, a learning model is configured using actual component data of a laboratory set to measure the fastening force. The data is processed by the same method as a data processing method that has been applied to the actual component data. Subsequently, in an actual factory, the process data is input to the learning model, and a discriminant operation is performed.

Here, classes are allocated to the fastening force of the bolt in desired section units (e.g., by each 1 kN from 50 kN to 80 kN). Characteristics having the allocated classes differ from each other by fastening forces. The characteristics are compared with an input signal, and the fastening force of the bolt is estimated by determining the input signal using the class having the highest similarity. Hereinafter, detail steps of the method of estimating the clamp force of the bolt in accordance with various aspects of the present invention will be described in more detail with reference to FIGS. 3A to 7.

FIG. 3A, FIG. 3B and FIG. 3C illustrate processes of generating, inputting, and processing the learning signal data.

According to short time Fourier transformation (STFT) of an input signal which is learning signal data, it may be understood that the frequency is increased as fastening time passes. The fastening component of the bolt is present to 8000 Hz. If variation in frequency of one time band is extracted from 0 Hz to 8000 Hz, new time series formed of amplitudes according to frequency may be obtained. Here, 3-stage fastening proceeds for 1.25 second, and total 35 periods (t1 to t35) are generated by dividing the present time by a certain time (0.035 second).

This operation is applied to all periods, thus forming new time series. Thereafter, amplitude limit is set, and data is divided. As such, the higher the frequency, the more data is stacked. Accordingly, if the data of the all periods are combined, new time series in which the frequency increases as time passes may be obtained. This becomes time series to be input to a long short term memory (LSTM). The larger the fastening force, the higher the frequency component. Therefore, time series in which a large amount of components are stacked is generated, so that time series in which characteristics according to the fastening force has been reflected is obtained.

A learning process by a nonlinear function of the signal input by the above-mentioned method is performed as illustrated in FIGS. 4A to 6.

The configuration of layers is as illustrated in FIG. 5. If generated time series are input to the input gate of the LSTM layer, they are sequentially input. In each node, an operation of applying a tanh function which is a nonlinear function, as illustrated in FIG. 6, representing mechanism of each cell by adding a value obtained by multiplying a node of a former time by the weight to a value obtained by multiplying a node of a current time by the weight, may be performed. In the instant case, a problem in which a slope value used by the Adam optimizer during the optimization operation is excessively small and thus vanishes may be solved, and the characteristics between the time series can also be clearly analyzed.

Next, the analyzed time series are input to the forget gate of long short term memory (LSTM), and importance by each time period is analyzed with a weight value. If data of a former time does not influence data of a latter time, a low weight is applied in the forget gate, so that it is removed. A dense layer integrates time series information, measures similarity of the discriminant signal with each class of 31 classes ranging from 50 kN to 81 kN, and determines a class having the highest similarity to be a discriminant fastening force.

In the case of the recurrent neural network (RNN) method including the long short term memory (LSTM), it is important to determine a weight for input information related to previous data. FIG. 7 is a diagram for describing an Adam optimization process using a loss function. Here, a loss value may be expressed by the following equation.

$$Loss value E = - {\sum }_{k} {t}_{k} log {y}_{k} \qquad [ Equation 1 ]$$

(k: class number, tₖ: k-th class similarity, yₖ: final output value)

In discriminating a discriminant signal, it is most important to optimize weight values of the LSTM layer and the dense layer through learning. To the present end, in each learning, a correct answer class value of the time series and similarity which is a final output value obtained by synthesizing all information using the dense layer as parameter to determine the loss value are used. The similarity has a value ranging from 0 to 1, and k which is a class number ranges from 1 to 31. As the loss value approaches 0, the learning may be regarded as having been satisfactorily performed. A method of determining a path toward 0 is the Adam optimizer.

The Adam optimizer may determine influence on the loss value when one weight finely varies, and operate gradually to reduce the loss value. For this, the slope value is required to be used. The Adam optimizer finds out the path by determining an index average of the slope and an index average of a squared value of the slope. If the path is continuously found through such iterative learning, weights are sufficiently updated, so that the loss value is reduced, and the accuracy of estimation is increased.

As described above, in an exemplary embodiment of the present invention, clamp force of a discriminant signal is estimated by a recurrent neural network method using a nonlinear function, a loss function, and Adam optimization. Consequently, a loss value may be minimized, and the accuracy of estimation may be enhanced.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A method of estimating clamp force of a bolt, the method comprising:
converting and analyzing, by a signal processing and analyzing device, a learning signal for the clamp force of the bolt, the learning signal being acquired by a data acquirement device;
comparing the learning signal classified into groups according to signal characteristics by the converting and analyzing, with a discriminant signal desired to be estimated; and
estimating, as clamp force of the discriminant signal, clamp force corresponding to a signal of a most similar group among the learning signal classified into the groups by the comparing.

2. The method of claim 1,
wherein the converting and analyzing includes signal-processing the input learning signal using a tanh function which is a nonlinear function.

3. The method of claim 1, wherein in time series data which is input as the learning signal in an input gate of long short term memory (LSTM), a weight is applied to each of nodes of the long short term memory (LSTM), and the converting and analyzing includes optimizing the weight by Adam optimization.

4. The method of claim 3, wherein, when the learning signal data is input to the input gate of the LSTM, the learning signal date is input to a forget gate of the long short term memory while information is exchanged between time series through a nonlinear function.

5. The method of claim 4,
wherein in the forget gate, influence of data of a front portion of the time series date on data of a rear portion thereof is determined.

6. The method of claim 3, wherein in the Adam optimization, the weight is optimized by tracing a course of reducing a loss value determined by a loss function.

7. The method of claim 6, wherein the loss value determined by the loss function is obtained by a following equation.
$$Loss value E = - {\sum }_{k} {t}_{k} log {y}_{k} ,$$
wherein the k is class number, the tₖ is k-th class similarity, and the yₖ is a final output value.

8. The method of claim 7,
wherein the k-th class similarity has a value ranging from 0 to 1, and
wherein the class number has a value ranging from 1 to 31.
